(19) United States
(12) Patent Application Publication
(10) Pub. No.: US 2016/0119147 A1
(43) Pub. Date: Apr. 28, 2016

(54) Method and System of Online Content Review, Authentication, and Certification

(71) Applicants: Mohammed Mustafa Saidalavi, Abu Dhabi (AE); Anjan Bose, Bangkok (TH)

(72) Inventors: Mohammed Mustafa Saidalavi, Abu Dhabi (AE); Anjan Bose, Bangkok (TH)

(21) Appl. No.: 14/921,811

(22) Filed: Oct. 23, 2015

Related U.S. Application Data
(60) Provisional application No. 62/068,271, filed on Oct. 24, 2014.

(51) Int. Cl. H04L 9/32; G06F 17/30

(52) U.S. Cl. CPC H04L 9/3247; G06F 17/30864; H04L 2209/72

(57) ABSTRACT

A method and apparatus for the certification, review, and authentication of scientific and academic content produced by a content creator and certified by relevant credible and established entities through a scientific framework that depends on online interoperable systems, and presents such content to consumers through a system that provides automatic measures for notifying the user of the authenticity of the matter. While prior systems have been proposed for content verification, most purely apply for fact checking of numbers and figures and to establish what the end parties guarantee to have exchanged is true. On the other hand, this method and apparatus provides a technical and conceptual framework for authenticating and/or reviewing bodies and the content creators to engage in a revenue model while certifying the content not only with hard facts and figures but also abstract nature and conceptual accuracy.

### CONTINUITY

This application is a non-provisional application of provisional patent application No. 62/068,271, filed on Oct. 24, 2014, and priority is claimed thereto.

### FIELD OF THE PRESENT INVENTION

The present invention relates to online content, and more specifically to the verification and authentication of online content, providing credibility to the online content, and facilitating and expediting the research process through authenticated and/or certified sources.

### BACKGROUND OF THE PRESENT INVENTION

The Internet has become the universal medium for knowledge exchange and a ubiquitous platform for seeking and validating information. Numerous information traverses this platform every second and unquestionably, the first place that comes to people's mind for answering their query is the Internet.

While scholarly and scientific materials can be accessed through academic networks, including in the offline context, it is usual for an individual to resort to online information on the internet for searching and also publishing content that can reach a worldwide audience. Historically, the Internet grew out of a United States defense project, and later transformed itself into a global infrastructure that keeps manifesting itself in newer ways with each passing day. While initially limited to big organizations which could connect and publish information, the ushering of the web 2.0 and later technologies has opened up the Internet to virtually anyone for publishing content. Thus, the credibility of the content that was attached to such big names can no longer be assumed when anybody on the Internet can publish content, including views, opinions, and research materials.

Surprisingly, unlike other critical technical Internet infrastructure (such as communication protocols, secure transactions, DNS authentication and root server hierarchy, Public Key Infrastructure/Secure Socket Layer (PKI/SSL) and other authentication protocols etc.), no standards or authentication framework currently exist, or have been made public, to automatically validate these scientific and academic online content, and integrate with user tools (such as Internet browsers) to facilitate the identification of authentic and reliable data by the user. This is evident, and a large gap in the dissemination of reliable internet content exists, considering the enormous potential the Internet offers and how it is being used on a daily basis.

Considering the daily number of requests and demands for scientific, medical, and research work from different disciplines, particularly from students and researchers in those fields, the Internet offers very little measure of knowing if the content that is accessed has scientific or technical authenticity, and is what the creator or publisher claims as correct or authentic. Considering the heavy usage of the Internet by learners around the world, it is quite surprising that the core Internet architecture is not being used for automatically providing such information to the end user. This is also applicable to the Internet search operations carried out millions of times a day by Internet users all around the world. There is currently no framework available that allows a search to be carried out only on content that has passed the certification of reviewing bodies in terms of their academic and scientific merits.

Thus, there is a pressing need for establishing a framework that would allow a robust mechanism to be developed to validate content by suitable authorities, and integrate such validation within the Internet, and well as integrated into the user experience.

### SUMMARY OF THE PRESENT INVENTION

The present invention proposes the use of a universal review system and framework based on a model that suggests clear roles and interaction between the Internet Content Certification and Review Framework (ICCRF) authority, the CA (certificate issuing authority), other reviewing bodies, as well as Content creators (CC).

The ICCRF authority is configured to be the central coordinating mechanism which is responsible for the coordination of the information sharing, maintenance, and issuance of certificates for content that is analyzed and reviewed by the certification authorities employed by the ICCRF. The Internet provides instantaneous access to content as well as to knowledge bodies. There are thousands of documents that are created daily, covering scientific, academic and literary fields. For all of these creations, the value of the document can be enhanced, and the confidence of the online readers can be established if a systematic method of reviewing of such documents by peer experts and credible expert agencies is established.

Currently, there is no uniform mechanism for bringing the review of such journals into one standard framework. The proposed model of the present invention provides a clear structure and framework by which such tasks can be carried out systematically within the online platforms. The combination of the certification of content by identified expert agencies and the integration of a review mechanism is very useful for online readers and consumers of such works.

### BRIEF DESCRIPTION OF THE DRAWINGS OF THE PRESENT INVENTION

FIG. 1 displays a flow chart detailing the process of the system of the present invention.

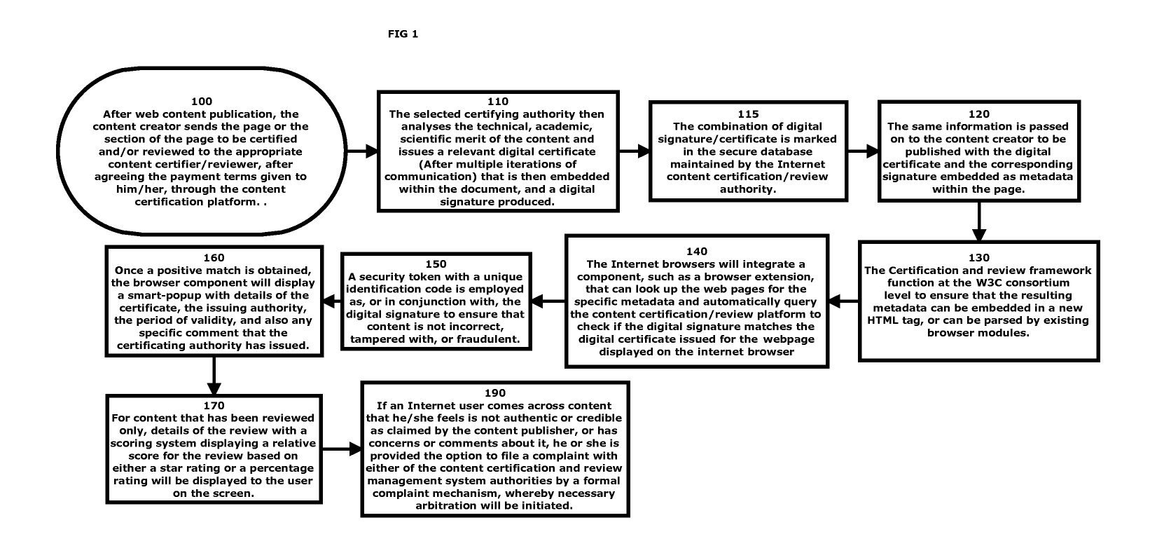

### DETAILED DESCRIPTION OF THE PREFERRED EMBODIMENT OF THE PRESENT INVENTION

The present invention is an online certification, review, and authentication system for online content which employs an online platform) to connect content authors to certifying bodies and reviewing bodies, and to provide an avenue for individuals using the internet to confirm that content is correct, certified, and/or authenticated by an approved reviewing and/or certifying body. A certification icon and/or an authentication icon are preferably displayed within a conventional web browser on a computer, mobile device, or other web-equipped digital device upon accessing certified web content. In the preferred embodiment of the present invention, the display of the certification icon and/or the authentication icon is preferably facilitated via a browser-integrated extension module, or similar script configured to integrate the functionality of the present invention into the web browser itself Fees are charged to the applicant whose content needs to certified and/or reviewed by certifying bodies and reviewing bodies for credibility and authentication. The present invention facilitates this authentication, certification, and reviewing processes, and facilitates the display of the results of these processes within the web browser, preferably along side of the authenticated content. The framework preferably employed by the system of the present invention is outlined as follows:

A) Certifying bodies and reviewing bodies with the identified and authenticated credentials and agreements with leading expert agencies from academic, research, medical and technology fields related to the field of the content to be certified are selected to be included in the reviewing and certification pool. (this list is not exhaustive but indicative)

B) The certifying and reviewing bodies have specific bilateral agreements worked out with individual agencies for terms of service and corresponding payments.
a. The expert agencies lending to the certifying bodies and reviewing bodies will be paid a share of the fees charged to the applicant whose content needs to certified/reviewed. The fees charged by the certifying/reviewing bodies can be according to a given scale that is proportional to the credibility/demand/popularity/value of the certifying agency.
b. The online platform is preferably equipped with systems for the content submitting applicant to choose a certifier/reviewer for the submitted content based on his/her choice. He or she can either decide to get his content certified, reviewed, or both.
c. The platform available for applicants requesting certification of created content will provide multiple choices for the applicant to select his or her certifier and reviewer based on the amount that he or she is willing to pay. The system will provide an automatic cost method, as well as the possibility of obtaining quotes from the certifier and/or reviewer. The certification authority preferably has the option to choose the quoting policy to be either automatic or manual.

C) Fundamentals of operation of the system of the present invention:
i. Types of content that can be requested for certification includes any web content that is published on a website. Either an entire web page or part of the page can be requested for certification. Additionally, portable documents such as .pdf and other notation capable documents may also be requested for certification. Likewise, all embedded contents, such as Images, Videos, etc. also will be covered in the scope of certification and review imposed via certification standards of the system of the present invention.

b. The preferred process of use of the integrated system of the present invention is preferably as follows:
i. Once a webpage has been published, the content creator sends the page or the section of the page to be certified and/or reviewed to the appropriate content certifier/reviewer, after agreeing the payment terms given to him/her, through the content certification platform. (100)
ii. The selected certifying authority then analyses the technical/academic/scientific merit of the content and issues a relevant digital certificate (After multiple iterations of communication) that is then embedded within the document, and a digital signature produced. (110)
iii. The combination of digital signature/certificate is marked in the secure database maintained by the Internet content certification/review authority. (115)
iv. The same information is passed on to the content creator to be published with the digital certificate and the corresponding signature embedded as metadata within the page. (120)
v. The Certification and review framework function at the W3C consortium level to ensure that the resulting metadata can be embedded in a new HTML tag, or can be parsed by existing browser modules. (130)
vi. The Internet browsers (both full and mobile-optimized versions) will integrate a component, such as a browser extension, that can look up the web pages for the specific metadata and automatically query the content certification/review platform to check if the digital signature matches the digital certificate issued for the webpage displayed on the internet browser. (140) A security token with a unique identification code is employed as, or in conjunction with, the digital signature to ensure that content is not incorrect, tampered with, or fraudulent. (150)
vii. Once a positive match is obtained, the browser component will display a smart-popup with details of the certificate, the issuing authority, the period of validity, and also any specific comment that the certificating authority has issued. (160) Similarly, for content that has been reviewed only, details of the review with a scoring system displaying a relative score for the review based on either a star rating or a percentage rating will be displayed to the user on the screen. (170)
viii. The user is provided a choice, through the browser component, to select all other content that matches a) the same topic, b) a similar field of interest, c) content issued by the same certifying authority, and/or d) view other articles reviewed by the same reviewer(s). (180)
ix. If an Internet user comes across content that he/she feels is not authentic or credible as claimed by the content publisher, or has concerns or comments about it, he or she is provided the option to file a complaint with either of the content certification and review management system authorities by a formal complaint mechanism, whereby necessary arbitration will be initiated. (190)

Key features and functions of the system of the present invention:

1) The system of the present invention is tamper-proof. The tamper-proofing element of the system of the present invention functions by mutual interaction of the browser with the Internet Content Certification/Review platform and the web site in question. If the content is fabricated by a third party to emulate the digital certificate, the special security token that is unique to the content, as maintained by the certification/review framework, will return a different value and alert the user through the browser component that the content is fake or hacked.

2) The system of the present invention allows a partial portion or a section of a webpage/website to be submitted for certification and review. The platform of the present invention is technology neutral since it depends on universal browser server interaction architecture. The present invention accomplishes this by parsing and analyzing individual segments of a webpage to check for verified, certified, and/or authenticated portions.

3) The system of the present invention allows the Internet user to narrow down his or her search based on academic/scientific/literary content that has been vetted and reviewed and also select based on certifying authorities/reviewers, thus reducing endless searching of content that does not meet such standards and eliminates frustration, saves time and builds confidence on the online system.

4) The system of the present invention provides a unique revenue model for businesses, particularly large reputed organizations, from technical, medical science, and literature fields who frequently publish online content. With the deluge of content that can be certified/reviewed online, the system provides a model of revenue for the content certifier and reviewers, as well as the organizing body that maintains the framework of the present invention.

5) The system can also be harnessed to produce revenue by providing the option to Internet users to pay for specific services—such as getting an aggregated list of certified content, narrowing down selection criteria or reviewed items, the ability to view content produced by certain publishers, etc.

6) The infrastructure of the system of the present invention includes the integration of the system within portable document readers such as Adobe Acrobat™, ensuring all functions of the system within the Browser can be emulated within these programs (as well as their web-based extensions), enabling Internet connected systems to automatically query the platform and generate a display menu for the user to navigate the certification/review details for digital documents that are downloaded from the certified websites.

7) The system will not introduce any noticeable latency to the internet traffic, or affect the user experience while browsing Internet content. The system of the present invention is configured to build greater trust and confidence in online content, as well as to reduce plagiarism of online material, as the user can very quickly discover details on the subject of research.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A process for reviewing and authenticating web content comprising:
a content creator creating web content;
the content creator publishing the web content to the internet;
the content creator submitting the web content to a content reviewer via a content certification platform;
the content reviewer analyzing the merits of the online content regarding the following: technical merits, academic merits, scientific merits;
the content reviewer issuing a relevant digital certificate for the web content;
the content certification platform embedding the digital certificate into the web content;
the content certification platform generating a digital signature;
the content certification platform maintaining a copy of the digital signature in an Internet content certification authority database;
the content certification platform maintaining a copy of the digital certificate in the Internet content certification authority database;
the content certification platform conveying the digital signature to the content creator;
the content creator embedding the digital signature and digital certificate as metadata within the published web content;
equipping a web browser with a browser extension configured to interface with the Internet content certification authority database to query the metadata; and
displaying the web content with accompanying digital signature on the Internet as certified content.

2. The method of claim 1, further comprising: the content creator agreeing to terms of payment via the content certification platform.

3. The method of claim 1, wherein said internet content certification authority database is secured with encryption.

4. The method of claim 1, wherein the review is conducted at the WQ3C consortium level.

5. A method for certifying content for display on the internet comprising:
a content creator creating content;
the content creator submitting the content for review to a content certification authority via a content certification platform;
the content certification platform assigning a reviewer to review and certify the accuracy of the content;
the reviewer reviewing and certifying the content as certified content; the content certification platform issuing a digital certificate and a digital signature for the certified content;
the content certification platform saving a copy of the digital certificate and the digital signature to a secure database;
the content certification platform transferring the digital certificate and the digital signature to the content creator;
the content creator embedding the digital certificate and the digital signature to the certified content as metadata; and
the content creator publishing the certified content to the internet.
